(19) United States
(12) Patent Application Publication
(10) Pub. No.: US 2025/0228158 A1
(43) Pub. Date: Jul. 17, 2025

(54) VEHICLE SKID PLATE

(71) Applicant: EXMARK MANUFACTURING COMPANY INCORPORATED, Beatrice, NE (US)

(72) Inventor: Nickolas T. Moore, Beatrice, NE (US)

(21) Appl. No.: 19/016,368

(22) Filed: Jan. 10, 2025

Related U.S. Application Data
(60) Provisional application No. 63/620,314, filed on Jan. 12, 2024.

(51) Int. Cl. A01D 34/81; A01D 34/64; A01D 69/02; A01D 101/00; B60K 1/02

(52) U.S. Cl. CPC A01D 34/81; A01D 34/64; A01D 69/02; A01D 2101/00; B60K 1/02

(57) ABSTRACT

The technology disclosed herein relates to a vehicle skid plate. A first coupling structure is on a first lateral end and a second coupling structure is on a second lateral end. The first coupling structure and second coupling structure are configured to couple to a vehicle frame. A first lateral plate surface extends between the first coupling structure and the second coupling structure. A second lateral plate surface extends between the first coupling structure and the first lateral plate surface. A third lateral plate surface extends between the second coupling structure and the first lateral plate surface. The first lateral plate surface is configured to be vertically offset above each of the second lateral plate surface and the third lateral plate surface.

### PRIORITY APPLICATION DATA

This application claims priority to U.S. Provisional Patent Application Ser. No. 63/620,314, filed Jan. 12, 2024, the disclosure of which is incorporated herein by reference.

### TECHNOLOGICAL FIELD

The present disclosure is generally related to a skid plate. More particularly, the present disclosure is related to a vehicle skid plate.

### SUMMARY

The present technology relates to a vehicle skid plate. The vehicle skid plate has a first coupling structure on a first lateral end and a second coupling structure on a second lateral end. The first coupling structure and second coupling structure are configured to couple to a vehicle frame. A first lateral plate surface extends between the first coupling structure and the second coupling structure. A second lateral plate surface extends between the first coupling structure and the first lateral plate surface. A third lateral plate surface extends between the second coupling structure and the first lateral plate surface. The first lateral plate surface is configured to be vertically offset above each of the second lateral plate surface and the third lateral plate surface.

In some such embodiments, the vertical offset between the first lateral plate surface and each of the second lateral plate surface and the third lateral plate surface is greater than 1.5 inches. Additionally or alternatively, the first lateral plate surface has a first width, the second lateral plate surface has a second width, and the third lateral plate surface has a third width, and the first width is at least 75% of each of the second width and the third width. Additionally or alternatively, the first lateral end has a first flange extending outward from the second lateral plate surface and the second lateral end has a second flange extending outward from the third lateral plate surface.

Additionally or alternatively, each of the first coupling structure and the second coupling structure are fastener openings configured to be aligned with mating openings in a vehicle frame to receive a fastener. Additionally or alternatively, the second lateral plate surface and the third lateral plate surface each define an access opening configured to provide access therethrough. Additionally or alternatively, the skid plate has a third coupling structure between the second lateral plate surface and the third lateral plate surface. Additionally or alternatively, the skid plate has a first plate frame integral with the first lateral plate surface, second lateral plate surface, and third lateral plate surface. The first plate frame extends along a first longitudinal end of the vehicle skid plate.

Additionally or alternatively, the first plate frame includes bar stock. Additionally or alternatively, the skid plate has a second plate frame integral with the first lateral plate surface, second lateral plate surface, and third lateral plate surface. The second plate frame extends along a second longitudinal end of the vehicle skid plate. Additionally or alternatively, the second lateral plate surface has a leading guide flange extending outward and upward from a first longitudinal end of the second lateral plate surface. The second lateral plate surface can additionally or alternatively have a trailing guide flange extending outward and upward from a second longitudinal end of the second lateral plate surface. Additionally or alternatively, the third lateral plate surface has a leading guide flange extending outward and upward from a first longitudinal end of the third lateral plate surface, and a trailing guide flange extending outward and upward from a second longitudinal end of the third lateral plate surface.

Some embodiments of the technology disclosed herein relate to a grounds maintenance vehicle. A vehicle frame extends between a first end and a second end in a longitudinal direction. A first drive motor is coupled to the frame. A first ground engaging member is in mechanical communication with the first drive motor. A second drive motor is coupled to the frame. A second ground engaging member is in mechanical communication with the second drive motor. A vehicle skid plate has a first lateral end having a first coupling structure coupled to the vehicle frame and a second lateral end having a second coupling structure coupled to the vehicle frame. A first lateral plate surface extends between the first coupling structure and the second coupling structure. The first lateral plate surface is positioned between the first drive motor and the second drive motor. A second lateral plate surface extends between the first coupling structure and the first lateral plate surface. The second lateral plate surface is positioned below the first drive motor. A third lateral plate surface extends between the second coupling structure and the first lateral plate surface. The third lateral plate surface is positioned below the second drive motor. The first lateral plate surface is offset vertically above the second lateral plate surface and the third lateral plate surface.

In some such embodiments, the grounds maintenance vehicle is a lawn mower. Additionally or alternatively, the vertical distance between the second lateral plate surface and the first drive motor is between ⅛-inch and ⅜-inch. Additionally or alternatively, the vehicle has a first transaxle including the first drive motor and a second transaxle including the second drive motor. Additionally or alternatively, the second lateral plate surface has a leading guide flange extending outward and upward from a first longitudinal end of the second lateral plate surface, and a trailing guide flange extending outward and upward from a second longitudinal end of the second lateral plate surface.

Additionally or alternatively, the third lateral plate surface has a leading guide flange extending outward and upward from a first longitudinal end of the third lateral plate surface, and a trailing guide flange extending outward and upward from a second longitudinal end of the third lateral plate surface. Additionally or alternatively, the second lateral plate surface and the third lateral plate surface each define an access opening configured to provide access therethrough. Additionally or alternatively, the vertical distance between the first lateral plate surface and each of the second lateral plate surface and the third lateral plate surface is greater than 1.5 inches. Additionally or alternatively, the first lateral plate surface has a first width, the second lateral plate surface has a second width, and the third lateral plate surface has a third width, and the first width is at least 75% of each of the second width and the third width.

The above summary is not intended to describe each embodiment or every implementation. Rather, a more complete understanding of illustrative embodiments will become apparent and appreciated by reference to the following Detailed Description and claims in view of the accompanying figures of the drawing.

### BRIEF DESCRIPTION OF THE DRAWINGS

The present technology may be more completely understood and appreciated in consideration of the following detailed description of various embodiments in connection with the accompanying drawings.

FIG. 1 is a first perspective view of an example vehicle skid plate consistent with the currently described technology.

FIG. 2 is a second perspective view of an example vehicle skid plate consistent with FIG. 1.

FIG. 3 is a perspective view of an example implementation of the current technology in a ground maintenance vehicle.

FIG. 4 is partial facing view of the example implementation of FIG. 3.

The figures are rendered primarily for clarity and, as a result, are not necessarily drawn to scale. Moreover, various structure/components, including but not limited to fasteners, electrical components (wiring, cables, etc.), and the like, may be shown diagrammatically or removed from some or all of the views to better illustrate aspects of the depicted embodiments, or where inclusion of such structure/components is not necessary to an understanding of the various exemplary embodiments described herein. The lack of illustration/description of such structure/components in a particular figure is, however, not to be interpreted as limiting the scope of the various embodiments in any way.

### DETAILED DESCRIPTION

In the following detailed description of illustrative embodiments, reference is made to the accompanying figures of the drawing which form a part hereof. It is to be understood that other embodiments, which may not be described and/or illustrated herein, are certainly contemplated.

All headings provided herein are for the convenience of the reader and should not be used to limit the meaning of any text that follows the heading, unless so specified. Moreover, unless otherwise indicated, all numbers expressing quantities, and all terms expressing direction/orientation (e.g., vertical, horizontal, parallel, perpendicular, etc.) in the specification and claims are to be understood as being modified in all instances by the term “about.” The term “and/or” (if used) means one or all of the listed elements or a combination of any two or more of the listed elements. The term “i.e.” is used as an abbreviation for the Latin phrase id est and means “that is.” The term “e.g.” is used as an abbreviation for the Latin phrase exempli gratia and means “for example.”

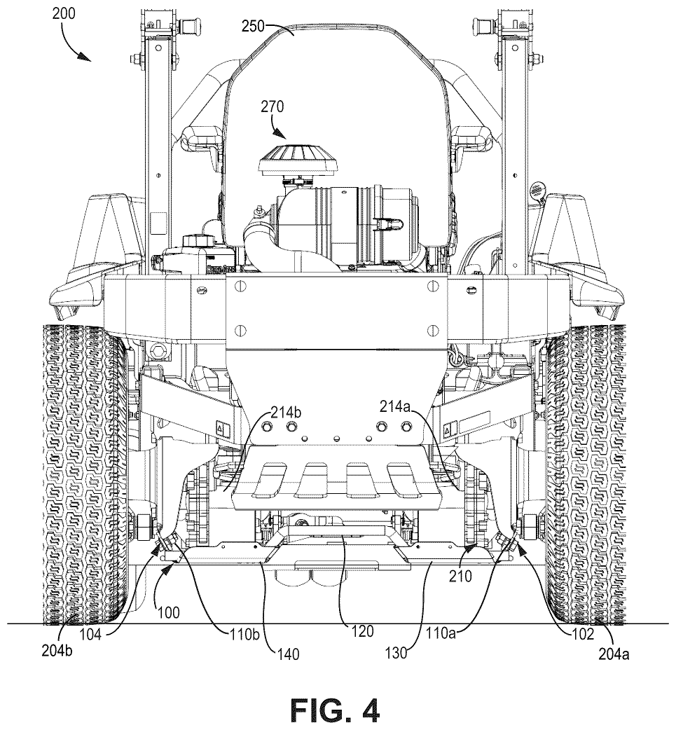

It is noted that the terms “have,” “include,” “comprise,” and variations thereof, do not have a limiting meaning, and are used in their open-ended sense to generally mean “including, but not limited to,” where the terms appear in the accompanying description and claims. Further, “a,” “an,” “the,” “at least one,” and “one or more” are used interchangeably herein. Moreover, relative terms such as “left,” “right,” “front,” “fore,” “forward,” “rear,” “aft,” “rearward,” “top,” “bottom,” “side,” “upper,” “lower,” “above,” “below,” “horizontal,” “vertical,” and the like may be used herein and, if so, are from the perspective shown in the particular figure, or while the vehicle is in an operating configuration (e.g., while the vehicle is positioned such that wheels rest upon a generally horizontal ground surface as shown in FIG. 4). These terms are used only to simplify the description, however, and not to limit the interpretation of any embodiment described.

Still further, the suffixes “a” and “b” are used throughout this description to denote various left-and right-side parts/features, respectively. However, in most pertinent respects, the parts/features denoted with “a” and “b” suffixes are substantially identical to, or mirror images of, one another. It is understood that, unless otherwise noted, the description of an individual part/feature (e.g., part/feature identified with an “a” suffix) also applies to the opposing part/feature (e.g., part/feature identified with a “b” suffix). Similarly, the description of a part/feature identified with no suffix may apply, unless noted otherwise, to both the corresponding left and right part/feature.

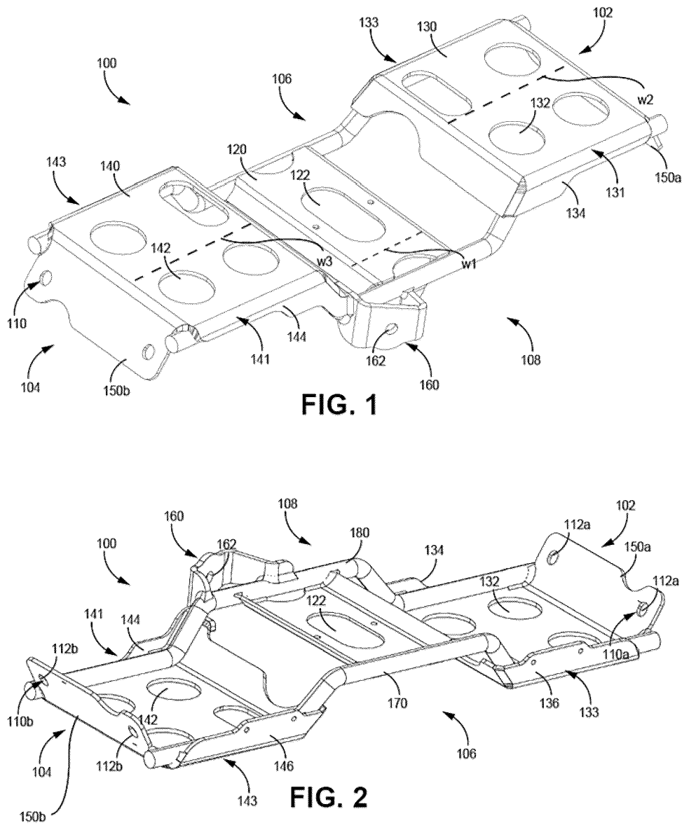

FIG. 1 is a perspective view of an example vehicle skid plate 100 consistent with the current technology. The skid plate 100 is generally configured to be coupled to the underside of a vehicle. The skid plate 100 is generally configured to be positioned between a ground surface and components on the underside of the vehicle to prevent direct impact between the ground or objects on the ground with the components on the underside of the vehicle. The skid plate 100 generally has a coupling structure 110, a first lateral plate surface 120, a second lateral plate surface 130, and a third lateral plate surface 140.

The coupling structure 110 of the skid plate 100 is generally configured to be coupled to a vehicle frame. In some embodiments the coupling structure 110 is configured to be directly coupled to a vehicle frame, such as by making direct contact with the vehicle frame. In other embodiments the coupling structure 110 is configured to be indirectly coupled to a vehicle frame, such as where there is an intervening component that couples the skid plate 100 to the vehicle frame.

The skid plate 100 has a first lateral end 102 and a second lateral end 104. A first coupling structure 110a is positioned towards the first lateral end 102, and a second coupling structure 110b is positioned towards the second lateral end 104. The first coupling structure 110a and second coupling structure 110b are each configured to couple to a vehicle frame. In the current example, the first coupling structure 110a and the second coupling structure 110b are each fastener openings 112a, 112b that are configured to be aligned with mating openings in a vehicle frame. The fastener openings 112a, 112b are each configured to receive a fastener. Each fastener is configured to engage a fastener opening 112a, 112b and a mating opening in the vehicle frame to fix the vehicle skid plate 100 to the vehicle frame. The type of fastener is not particularly limited and can include bolts, screws, washers, nuts, and the like. In some embodiments one or both coupling structures 110a, 110b do not include openings and can be, for example, a weld surface that is configured to be welded to a vehicle frame.

The first lateral plate surface 120 is generally configured to prevent direct impact between the ground (or object on the ground) with components on the underside of the vehicle across a first area. The first lateral plate surface 120 extends between the first coupling structure 110a and the second coupling structure 110b. The first lateral plate surface 120 can be constructed of a variety of different materials and combinations of materials. In some embodiments the first lateral plate surface 120 is constructed of steel, aluminum, or the like. The first lateral plate surface 120 can be a surface of a structural component such as a plate, disk, bar, or other structural member. In some embodiments the first lateral plate surface 120 is formed from fabricated sheet metal such as press-formed or roll-formed sheet metal. The first lateral plate surface 120 can be formed from extruded metal or cast metal in other examples. In some embodiments, the first lateral plate surface 120 is configured to face the ground surface upon installation of the skid plate 100 to a vehicle. The first lateral plate surface 120 generally has a first width w1, where the first width is measured in the lateral direction. In some embodiments, at least a portion of the first lateral plate surface 120 defines a plane. In the current example, the first lateral plate surface 120 defines one or more openings 122. In some embodiments one or more openings 122 can be configured to provide access to vehicle components vertically above the first lateral plate surface 120. In some embodiments one or more access openings are sized to accommodate the passage of a component (such as a filter) for installation and removal. In some embodiments one or more access openings are sized to accommodate a hand grasping a component (such as a filter) during the installation and/or removal process. In some embodiments one or more openings 122 can advantageously facilitate the expulsion of debris that may enter the space between the skid plate 100 and the underside components of the vehicle.

The second lateral plate surface 130 is generally configured to prevent direct impact between the ground (or object on the ground) with components on the underside of the vehicle across a second area. The second lateral plate surface 130 extends between the first coupling structure 110a and the first lateral plate surface 120. The second lateral plate surface 130 can be constructed of a variety of different materials and combinations of materials consistent with the first lateral plate surface 120. The second lateral plate surface 130 can be a surface of a structural component such as a plate, disk, bar, or other structural member. In some embodiments, the second lateral plate surface 130 is configured to face the ground surface upon installation of the skid plate 100 to a vehicle. The second lateral plate surface 130 generally has a second width w2, where the second width is measured in the lateral direction. In some embodiments, at least a portion of the second lateral plate surface 130 defines a plane. In the current example, the second lateral plate surface 130 defines one or more openings 132. In some embodiments an opening 132 of the one or more openings can be an access opening configured to provide access to vehicle components vertically above the second lateral plate surface 130. In some embodiments an opening 132 of the one or more openings can advantageously facilitate the expulsion of debris that may enter the space between the skid plate 100 and the underside components of the vehicle.

The third lateral plate surface 140 is generally configured to prevent direct impact between the ground (or object on the ground) with components on the underside of the vehicle across a second area. The third lateral plate surface 140 extends between the second coupling structure 110b and the first lateral plate surface 120. The third lateral plate surface 140 can be constructed of a variety of different materials and combinations of materials consistent with the first lateral plate surface 120. The third lateral plate surface 140 can be a surface of a structural component such as a plate, disk, bar, or other structural member. In some embodiments, the third lateral plate surface 140 is configured to face the ground surface upon installation of the skid plate 100 to a vehicle. The third lateral plate surface 140 generally has a third width w3, where the third width is measured in the lateral direction. In some embodiments, at least a portion of the third lateral plate surface 140 defines a plane. In the current example, the third lateral plate surface 140 defines one or more openings 142. In some embodiments one or more openings 142 can be an access opening configured to provide access to vehicle components vertically above the third lateral plate surface 140. In some embodiments one or more openings 142 can advantageously facilitate the expulsion of debris that may enter the space between the skid plate 100 and the underside components of the vehicle.

In various embodiments the first lateral plate surface 120 is configured to be vertically offset from each of the second lateral plate surface 130 and the third lateral plate surface 140, such as when the skid plate 100 is installed on a vehicle. The first lateral plate surface 120 can be configured to be offset vertically above each of the second lateral plate surface 130 and the third lateral plate surface 140. The offset between the first lateral plate surface 120 and each of the second lateral plate surface 130 and the third lateral plate surface 140 may advantageously increase the ground clearance of the vehicle. In some embodiments the first lateral plate surface 120 is at least 1.5 or 2.0 inches above the second lateral plate surface 130 and the third lateral plate surface 140. In some embodiments the first lateral plate surface 120 is about 2.0 to 3.0 inches above the second lateral plate surface 130 and the third lateral plate surface 140.

In some embodiments, the first width w1 is at least 75% of the second width w2. In some embodiments, the first width w1 is at least 75% of the third width w3.

In the current example, the first lateral end 102 of the skid plate 100 has a first flange 150a extending outward from the second lateral plate surface 130. The second lateral end 104 has a second flange 150b extending outward from the third lateral plate surface 140. The first flange 150a defines the first coupling structure 110a and the second flange 150b defines the second coupling structure 110b. While not limited to such a configuration, in the current example, the first flange 150a extends non-vertically from the second lateral plate surface 130 and the second flange 150b extends non-vertically from the third lateral plate surface 140, where “non-vertically” is used to mean not 90° from a horizontal plane. Additionally, while not limited to such a configuration, in the current example, the first flange 150a extends obliquely from the second lateral plate surface 130 and the second flange 150b extends obliquely from the third lateral plate surface 140. In some embodiments, the first flange 150a and/or the second flange 150b can be omitted. In such examples, the couplings structures 110a, 110b can be defined by the second lateral plate surface 130 and the third lateral plate surface 140, respectively.

In various embodiments, the skid plate 100 has a third coupling structure 160. The third coupling structure 160 can generally be configured to couple to another vehicle component. In the current example, the third coupling structure 160 is positioned between the second lateral plate surface 130 and the third lateral plate surface 140. In particular, the third coupling structure 160 is positioned laterally between the second lateral plate surface 130 and the third lateral plate surface 140. In the current example, the third coupling structure 160 includes a fastener opening 162 that is configured to receive a fastener. The fastener opening 162 can be configured to align with a mating fastener opening defined by a vehicle, and a fastener can be received by the fastener opening 162 and the mating fastener opening to mount the skid plate 100. In some embodiments the third coupling structure 160 can have an alternate configuration. For example, the third coupling structure 160 can define a weld surface that is configured to be welded to a vehicle component. In some embodiments a third coupling structure 160 can be omitted.

In various embodiments the skid plate 100 can have one or more frame components that are configured to relatively improve the structural integrity of the skit plate 100. In the current example, the skid plate 100 has a first plate frame 170 that is integral with the first lateral plate surface 120, the second lateral plate surface 130, and the third lateral plate surface 140. The phrase “integral with” is used herein to mean that the first plate frame 170 forms a unitary, singular component with the first lateral plate surface 120, the second lateral plate surface 130, and the third lateral plate surface 140. In various embodiments the first plate frame 170 is welded to each of the first lateral plate surface 120, the second lateral plate surface 130, and the third lateral plate surface 140. The first plate frame 170 extends along a first longitudinal end 106 of the vehicle skid plate 100.

The first plate frame 170 can be constructed of a variety of materials and combinations of materials. In various embodiments, the first plate frame 170 is constructed of bar stock. In some other embodiments the first plate frame 170 is constructed of metal tubing. In yet other embodiments the first plate frame 170 is defined by one or more flanges integral with the first lateral plate surface 120, the second lateral plate surface 130, and the third lateral plate surface 140.

In the current example, the skid plate 100 has a second plate frame 180 that is integral with the first lateral plate surface 120, the second lateral plate surface 130, and the third lateral plate surface 140. In various embodiments the second plate frame 180 is welded to each of the first lateral plate surface 120, the second lateral plate surface 130, and the third lateral plate surface 140. The second plate frame 180 extends along a second longitudinal end 108 of the vehicle skid plate 100. The second plate frame 180 can be constructed of materials consistent with the first plate frame 170.

In the current example, the first plate frame 170 and the second plate frame 180 are positioned vertically above each of the first lateral plate surface 120, the second lateral plate surface 130, and the third lateral plate surface 140. Such a configuration may advantageously provide a relative increase in the clearance between the skid plate 100 and a ground surface. In some embodiments, the first plate frame 170 and/or the second plate frame 180 can be omitted. In such an example, each of the lateral plate surfaces 120, 130, 140 can be directly coupled to an adjacent lateral plate surface 120, 130, 140.

In the current example, the second lateral plate surface 130 has a leading guide flange 134 extending outward and upward from a first longitudinal end 131 of the second lateral plate surface 130. The second lateral plate surface 130 also has a trailing guide flange 136 extending outward and upward from a second longitudinal end 133 of the second lateral plate surface 130. Such a configuration may advantageously prevent direct lateral force from the ground (or objects on the ground) on the front and back edge of the second lateral plate surface 130. Such a configuration may advantageously guide the ground (or objects on the ground) downward along the guide flange relative to the vehicle, which may prevent the ground from interfering with movement of the vehicle.

In the current example, the third lateral plate surface 140 has a leading guide flange 144 extending outward and upward from a first longitudinal end 141 of the third lateral plate surface 140. The third lateral plate surface 140 also has a trailing guide flange 146 extending outward and upward from a second longitudinal end 143 of the third lateral plate surface 140. Such a configuration may have the same advantages discussion above with reference to the guide flanges 134, 136 of the second lateral plate surface 130.

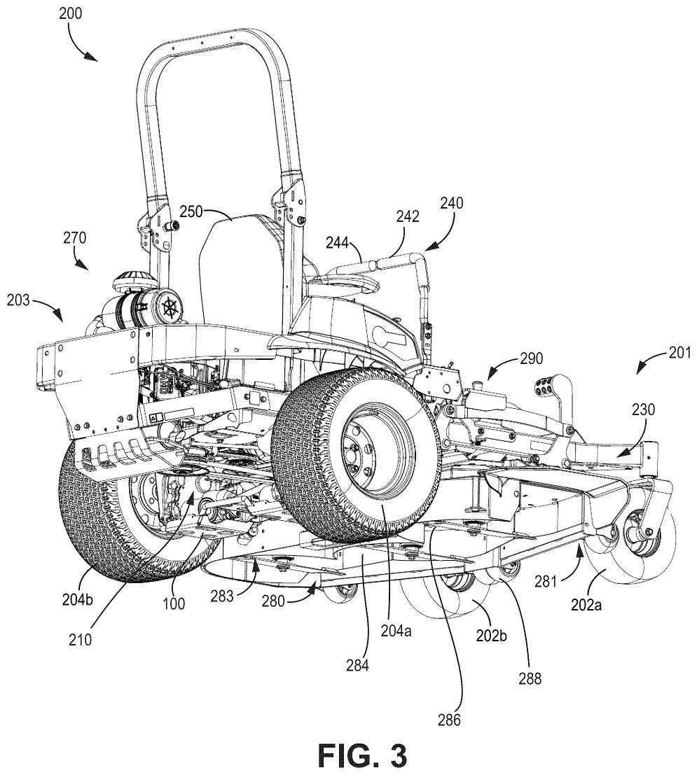

FIGS. 3-4 depict an example implementation of the current technology, where the vehicle skid plate 100 consistent with the discussion of FIGS. 1 and 2 is installed on an example vehicle 200. The vehicle 200 can be a grounds maintenance vehicle, in some embodiments. FIG. 3 illustrates a perspective view of the example vehicle 200, and FIG. 4 illustrates a partial rear view of the vehicle 200. The vehicle 200, in the current example, is a seated lawn mower. While embodiments are described herein with respect to such a mower, this disclosure is equally applicable to mowers having alternate configurations (e.g., walk-behind mowers and riding mowers). The embodiments also apply to other types of vehicles including other types of grounds maintenance vehicles (e.g., aerators, dethatchers, debris management systems, blowers, vacuums, sweepers, general purpose utility vehicles, etc.) without limitation.

The vehicle 200 generally has a frame 230 (of which a portion is visible) that is configured to support various vehicle components. The frame 230 has a first end 201, which can be a front end, and a second end 203, which can be a rear end. The frame 230 has a plurality of load bearing members. The frame 230 is generally configured to be propelled across the ground surface. In particular, ground engaging members 204 and 202 are coupled to the vehicle frame 230. Here the ground engaging members are drive wheels 204 and one or more caster wheels 202, but in some embodiments the ground engaging members can be tracks, rollers, and/or other types of wheels. The one or more caster wheels 202 are rotatably coupled to the vehicle frame 230 towards the first end 201 of the vehicle frame 230. The one or more caster wheels 202 are generally undriven wheels that are configured to accommodate directional motion of the maintenance vehicle 200 initiated and directed by the drive wheels 204. The one or more caster wheels 202 are generally freely swivelable about a vertical swivel axis relative to the vehicle frame 230.

The ground engaging members 204 are generally configured to propel the vehicle 200 over the ground surface and control the vehicle's direction. The ground engaging members 204 are generally in mechanical communication with a prime mover 270 (e.g., internal combustion engine or electric motor(s)) that is configured to selectively propel the ground engaging members 204 to propel the vehicle 200 across the ground. A left and a right ground engaging member 204 are coupled to left and right sides of a rear portion of the vehicle 200, respectively. The ground engaging members 204 may be independently powered by the prime mover 270 (e.g., via one or more hydraulic motors, transmissions, or the equivalent) so that they may be driven independently of one another. This permits spin or skid type turning in a zero radius turn manner by rotating one ground engaging member 204 in a forward direction while simultaneously rotating the other ground engaging member 204 in a reverse direction.

Although the illustrated vehicle 200 the drive wheels 204 in the rear, this configuration is not limiting. For example, other embodiments may reverse the location of the wheels, e.g., drive wheels in front and the caster wheel(s) in back. Moreover, other configurations may use different wheel configurations altogether, e.g., a tri-wheel configuration or a conventional front-wheel-steering configuration. Accordingly, other embodiments are possible without departing from the scope of the invention.

The prime mover 270 is coupled to the vehicle frame 230. The prime mover 270 is generally configured to drive each ground engaging member 204, which will be described in more detail below. The prime mover 270 can be an internal combustion engine in some embodiments. In some other embodiments the prime mover 270 is an electric motor. In various embodiments, the prime mover 270 has a driveshaft. The driveshaft is generally in mechanical communication with one or more ground engaging members 204 through a hydraulic transmission system, which will be described in more detail below.

The prime mover 270 is generally configured to be controlled by a user through one or more controllers 240, for example. The controllers 240 are in operative communication with the prime mover 270. The controllers 240 can have one or more handles 242, 244 that are configured to selectively propel and direct vehicle propulsion. In some embodiments a first handle 242 and a second handle 244 extend outward from the vehicle frame 230 and are each configured to be manually translated relative to the vehicle frame 230 to control operation of the vehicle 200. In the example depicted, the first handle 242 and the second handle 244 are each manually pivotable about a pivot. The first handle 242 and the second handle 244 are manually translated about their respective pivots to control operation of the vehicle 200.

In some embodiments, the first handle 242 and second handle 244 can be considered a twin lever controller, where translation of each handle 242, 244 controls the speed and rotational direction of a corresponding ground engaging member 204a, 204b. In this example, translation of the first handle 242 controls a first ground engaging member 204a and translation of the second handle 244 controls a second ground engaging member 204b. A drive wheel is considered to “correspond” to a particular handle when it is located on the same side of the vehicle, such that a drive wheel on the right side of the vehicle corresponds to a handle on the right side of the vehicle.

The vehicle 200 can have handles with other configurations as well. In some embodiments, a handle can be configured as a steering wheel. The vehicle 200 can have various alternative and additional controls that can be used by the operator to manipulate function of the vehicle 200. The one or more handles 242, 244 and/or various other controls of the controllers 240 are configured to be accessible to the operator positioned on the vehicle 200.

In the current example, the vehicle 200 is configured as a riding vehicle. As such, chair 250 is coupled to the vehicle frame 230. The chair 250 is one or more surface(s) adapted to support the body of a seated operator. The chair 250 is coupled to the vehicle frame 230 towards the second end 203. In alternative embodiments, the vehicle can be a stand-on vehicle or a walk-behind vehicle. In embodiments consistent with a stand-on vehicle, the vehicle has a standing platform that is configured to receive a standing operator. In such embodiments the one or more handles 242, 244 and other system controls are configured to be accessible to the standing operator.

An implement assembly 280 is generally configured to couple to, or be integrally formed with, a grounds maintenance vehicle. The implement assembly 280 is generally configured to perform a maintenance task on a surface, such as the ground surface. The implement assembly 280 has a first implement end 281 and a second implement end 283 and is generally configured for operational interaction with the ground surface. In this example, the first implement end 281 is the front end of the implement assembly 280 and the second implement end 283 is the back end of the implement assembly 280. In the current example, the implement assembly 280 is configured to be disposed between at least a portion of the vehicle frame 230 and the ground surface.

In the current example, where the vehicle 200 includes a lawn mower assembly, the implement assembly 280 is a cutting deck having a housing 282 defining a cutting chamber 284. Cutting blades 286 are rotatably disposed in the cutting chamber 284. As stated above, other cutting decks (e.g., belly-mounted decks, towed decks, reel units, etc.), as well as other implements, are contemplated within the scope of this disclosure. In the current example, during operation, power is selectively delivered to the cutting chamber 284 by the prime mover 270, whereby the cutting blades 286 rotate at a speed sufficient to sever grass and other vegetation over which the deck passes.

The implement assembly 280 can have a plurality of rollers 288 (e.g., anti-scalp rollers) configured to be disposed between the implement assembly 280 and a ground surface to limit contact between the implement assembly 280 and the ground surface. The plurality of rollers 288 can be configured to obstruct contact between the implement assembly 280 and the ground surface to reduce scalping of the ground surface as the implement assembly 280 translates across the ground surface.

A pre-selected operating height is generally defined between the implement assembly 280 and the ground surface for a specific height-of-cut setting. The operating height can be selected by a user through a height selection tool 290. The height selection tool 290 is configured to change a default vertical operating position of the implement assembly 280 relative to the vehicle frame 230, which changes the pre-selected operating height.

In various implementations of the current technology, the prime mover 270 is in mechanical communication with the ground engaging members 204a, 204b. A transmission system 210 is configured to transmit mechanical power from the prime mover 270 to each of the ground engaging members 204. A drive motor 214 is coupled to the vehicle frame 230. The drive motor 214 is in mechanical communication with a ground engaging member 204. In the current example, a first drive motor 214a is in mechanical communication with a first ground engaging member 204a and a second drive motor 214b is in mechanical communication with a second ground engaging member 204b. In some embodiments the drive motor 214 is a transaxle. In some other embodiments each drive motor 214 can be an electric motor.

In some embodiments the transmission system 210 is a hydraulic transmission system having a hydraulic pump assembly coupled to the vehicle frame 230. The hydraulic pump assembly 212 is in mechanical communication with the prime mover 270.

The vehicle skid plate 100 is consistent with vehicle skid plates discussed above with reference to FIGS. 1 and 2 and, as such, the description above is incorporated by reference herein. The vehicle skid plate 100 has a first lateral end 102 having a first coupling structure 110a coupled to the vehicle frame 230 and a second lateral 104 end having a second coupling structure 110b coupled to the vehicle frame 230. A first lateral plate surface 120 extends between the first coupling structure 110a and the second coupling structure 110b. The first lateral plate surface 120 is positioned between the first drive motor 214a and the second drive motor 214b. In particular, the first lateral plate surface 120 is positioned between the first drive motor 214a and the second drive motor 214b in the lateral direction.

The vehicle skid plate 100 has a second lateral plate surface 130 extending between the first coupling structure 110a and the first lateral plate surface 120. The second lateral plate surface 130 is positioned below the first drive motor 214a. The vertical distance between the second lateral plate surface 130 and the first drive motor 214a can be between ⅛-inch and ⅜-inch, in some embodiments. Such a configuration may advantageously balance desirable ground clearance while preventing impact to the first drive motor 214a by the component defining the second lateral plate surface 130. A third lateral plate surface 140 extends between the second coupling structure 110b and the first lateral plate surface 120. The third lateral plate surface 140 is positioned below the second drive motor 214b. The vertical distance between the third lateral plate surface 140 and the second drive motor 214b can be between ⅛-inch and ⅜-inch, in some embodiments. Such a configuration may advantageously balance desirable ground clearance while preventing impact to the second drive motor 214b by the component defining the third lateral plate surface 140.

The first lateral plate surface 120 is offset vertically above the second lateral plate surface 130. The first lateral plate surface 120 is offset vertically above the third lateral plate surface 140. The skid plate 100 configuration may advantageously conform to the underside components of the vehicle while maximizing ground clearance in the central area of the skid plate.

It should also be noted that, as used in this specification and the appended claims, the phrase “configured” describes a system, apparatus, or other structure that is constructed to perform a particular task or adopt a particular configuration. The word “configured” can be used interchangeably with similar words such as “arranged”, “constructed”, “manufactured”, and the like.

All publications and patent applications in this specification are indicative of the level of ordinary skill in the art to which this technology pertains. All publications and patent applications are herein incorporated by reference to the same extent as if each individual publication or patent application was specifically and individually indicated by reference. In the event that any inconsistency exists between the disclosure of the present application and the disclosure(s) of any document incorporated herein by reference, the disclosure of the present application shall govern.

This application is intended to cover adaptations or variations of the present subject matter. It is to be understood that the above description is intended to be illustrative, and not restrictive, and the claims are not limited to the illustrative embodiments as set forth herein.

What is claimed is:

1. A vehicle skid plate comprising:
a first coupling structure on a first lateral end, and a second coupling structure on a second lateral end, wherein the first coupling structure and second coupling structure are configured to couple to a vehicle frame;
a first lateral plate surface extending between the first coupling structure and the second coupling structure;
a second lateral plate surface extending between the first coupling structure and the first lateral plate surface; and
a third lateral plate surface extending between the second coupling structure and the first lateral plate surface, wherein the first lateral plate surface is configured to be vertically offset above each of the second lateral plate surface and the third lateral plate surface.

2. The vehicle skid plate of claim 1, wherein the vertical offset between the first lateral plate surface and each of the second lateral plate surface and the third lateral plate surface is greater than 1.5 inches.

3. The vehicle skid plate of claim 1, wherein the first lateral plate surface has a first width, the second lateral plate surface has a second width, and the third lateral plate surface has a third width, and the first width is at least 75% of each of the second width and the third width.

4. The vehicle skid plate of claim 1, wherein the first lateral end comprises a first flange extending outward from the second lateral plate surface and the second lateral end comprises a second flange extending outward from the third lateral plate surface.

5. The vehicle skid plate of claim 1, wherein each of the first coupling structure and the second coupling structure are fastener openings configured to be aligned with mating openings in a vehicle frame to receive a fastener.

6. The vehicle skid plate of claim 1, wherein the second lateral plate surface and the third lateral plate surface each define an access opening configured to provide access therethrough.

7. The vehicle skid plate of claim 1, further comprising a third coupling structure between the second lateral plate surface and the third lateral plate surface.

8. The vehicle skid plate of claim 1, further comprising a first plate frame integral with the first lateral plate surface, second lateral plate surface, and third lateral plate surface, wherein the first plate frame extends along a first longitudinal end of the vehicle skid plate.

9. The vehicle skid plate of claim 8, wherein the first plate frame comprises bar stock.

10. The vehicle skid plate of claim 8, further comprising a second plate frame integral with the first lateral plate surface, second lateral plate surface, and third lateral plate surface, wherein the second plate frame extends along a second longitudinal end of the vehicle skid plate.

11. The vehicle skid plate of claim 1, wherein the second lateral plate surface comprises a leading guide flange extending outward and upward from a first longitudinal end of the second lateral plate surface, and a trailing guide flange extending outward and upward from a second longitudinal end of the second lateral plate surface.

12. The vehicle skid plate of claim 1, wherein the third lateral plate surface comprises a leading guide flange extending outward and upward from a first longitudinal end of the third lateral plate surface, and a trailing guide flange extending outward and upward from a second longitudinal end of the third lateral plate surface.

13. A grounds maintenance vehicle comprising:
a vehicle frame extending between a first end and a second end in a longitudinal direction;
a first drive motor coupled to the frame;
a first ground engaging member in mechanical communication with the first drive motor;
a second drive motor coupled to the frame;
a second ground engaging member in mechanical communication with the second drive motor; and
a vehicle skid plate comprising:
a first lateral end having a first coupling structure coupled to the vehicle frame and a second lateral end having a second coupling structure coupled to the vehicle frame;
a first lateral plate surface extending between the first coupling structure and the second coupling structure, wherein the first lateral plate surface is positioned between the first drive motor and the second drive motor;
a second lateral plate surface extending between the first coupling structure and the first lateral plate surface, wherein the second lateral plate surface is positioned below the first drive motor; and
a third lateral plate surface extending between the second coupling structure and the first lateral plate surface, wherein the third lateral plate surface is positioned below the second drive motor, wherein the first lateral plate surface is offset vertically above the second lateral plate surface and the third lateral plate surface.

14. The grounds maintenance vehicle of claim 13, wherein the grounds maintenance vehicle is a lawn mower.

15. The grounds maintenance vehicle of claim 13, wherein the vertical distance between the second lateral plate surface and the first drive motor is between ⅛-inch and ⅜-inch.

16. The grounds maintenance vehicle of claim 13, further comprising a first transaxle comprising the first drive motor and a second transaxle comprising the second drive motor.

17. The grounds maintenance vehicle of claim 13, wherein the second lateral plate surface comprises a leading guide flange extending outward and upward from a first longitudinal end of the second lateral plate surface, and a trailing guide flange extending outward and upward from a second longitudinal end of the second lateral plate surface.

18. The grounds maintenance vehicle of claim 13, wherein the third lateral plate surface comprises a leading guide flange extending outward and upward from a first longitudinal end of the third lateral plate surface, and a trailing guide flange extending outward and upward from a second longitudinal end of the third lateral plate surface.

19. The grounds maintenance vehicle of claim 13, wherein the second lateral plate surface and the third lateral plate surface each define an access opening configured to provide access therethrough.

20. The grounds maintenance vehicle of claim 13, wherein the vertical distance between the first lateral plate surface and each of the second lateral plate surface and the third lateral plate surface is greater than 1.5 inches.

21. The grounds maintenance vehicle of claim 13, wherein the first lateral plate surface has a first width, the second lateral plate surface has a second width, and the third lateral plate surface has a third width, and the first width is at least 75% of each of the second width and the third width.
